(19) United States
(12) Patent Application Publication
(10) Pub. No.: US 2008/0011971 A1
(43) Pub. Date: Jan. 17, 2008

(54) Quick opening drain plug assembly

(75) Inventor: Robert H. Stoll, Alden, NY (US)

Correspondence Address: John C. Thompson, 69 Grayton Road, Tonawanda, NY, 14150, US

(73) Assignee: Jiffy-Tite Co., Inc.

(21) Appl. No.: 11/484,112

(22) Filed: Jul. 11, 2006

(51) Int. Cl. F16K 35/00

(52) U.S. Cl. 251/89

(57) ABSTRACT

A quick opening drain plug assembly for automotive radiators that can be readily opened even when in a difficult to reach location. The assembly includes a tubular fitting having first and second ends, the first end being adapted to be connected to a fluid reservoir, the fitting having a passageway extending from the first end to the second end; a tubular socket body secured to the second end of the fitting; a valve slidably mounted within the tubular socket body for sliding movement between open and closed positions, the valve having a tubular passageway which extends to an open end of the valve, the other end being closed, and side ports extending from an outer surface of the valve to the tubular passageway adjacent the closed end of the valve; a collar carried by the socket body and movable between extended and retracted positions to hold the valve in either a closed or an open position, and an abutment surface on the interior of the socket body and an outwardly extending flange on the valve to form a tight, fluid-proof seal on the exterior of the valve and to limit movement of the valve to the open position. When the valve is in the closed position it blocks the flow of fluid from the reservoir through the fitting, but when in the open position permits fluid to drain from the fluid reservoir.

### TECHNICAL FIELD

The present invention relates to a quick opening drain plug assembly for automotive radiators, and more particularly to one that can be readily opened even when in a difficult to reach location.

### BACKGROUND OF THE INVENTION

Radiator drain plugs are often in difficult to reach locations, and often are hard to open due to either the location of the plug or the cramped conditions which limit movement and make it hard to reach into the area around the plug with either hands or tools to loosen the plug. Also, typically when draining a radiator, there are two steps involved in actually getting the fluid to drain; initially, the radiator cap is removed; then either the drain plug is opened or the drain hose is removed, depending on the vehicle. However, in severe environments, such as the desert, where the ingress of sand in the open radiator is a concern, it is often not advisable to remove the radiator cap.

The prior art discloses many differing designs of radiator drain plugs, typical examples being U.S. Pat. Nos. 3,910,550, 4,449,692, 4,679,618, 5,246,202, 6,167,946, and Japanese published patent documents 63-68715 and 2004132221. In all of these patents the drain plug is opened by a twisting movement. U.S. Pat. Nos. 3,744,558 4,508,234 and 4,583,6507 all show that an in-out movement may be used to open the drain plug. In the first of these designs there is no positive securing structure to hold the parts in either their open or closed positions. In the later two designs, there are parts which may become separated from each other.

Other designs have been employed as oil pan drain plugs. Typical examples are U.S. Pat. Nos. 4,745,894 6,655,498 and 6,902,038. French patent 2,370,208 discloses a somewhat similar design where parts move against a compressible spring. In these various designs it should be noted that the oil in the crankcase is not under pressure.

### OBJECTS AND SUMMARY OF THE INVENTION

The present invention overcomes the difficulties set forth above in several ways. The proposed drain valve is operable easily with one hand and doesn't require any twisting or turning motions, but only a pushing motion. Also, since the proposed drain plug assembly or valve relies on radiator pressure in order to open properly, it does not require the extra step of removing the radiator cap. This also helps to keep any blowing foreign material from entering the radiator. Additionally, the pressure in the radiator helps the liquid to drain faster, resulting in a shorter time requirement for radiator fluid changes.

### BRIEF DESCRIPTION OF THE FIGURES

FIG. 1 is a sectional side view of the quick opening drain plug assembly of this invention when in its closed position.

FIG. 2 is a sectional side view of the quick opening drain plug assembly of this invention when in its open position.

FIG. 3 is an exploded view of the quick opening drain plug assembly of this invention.

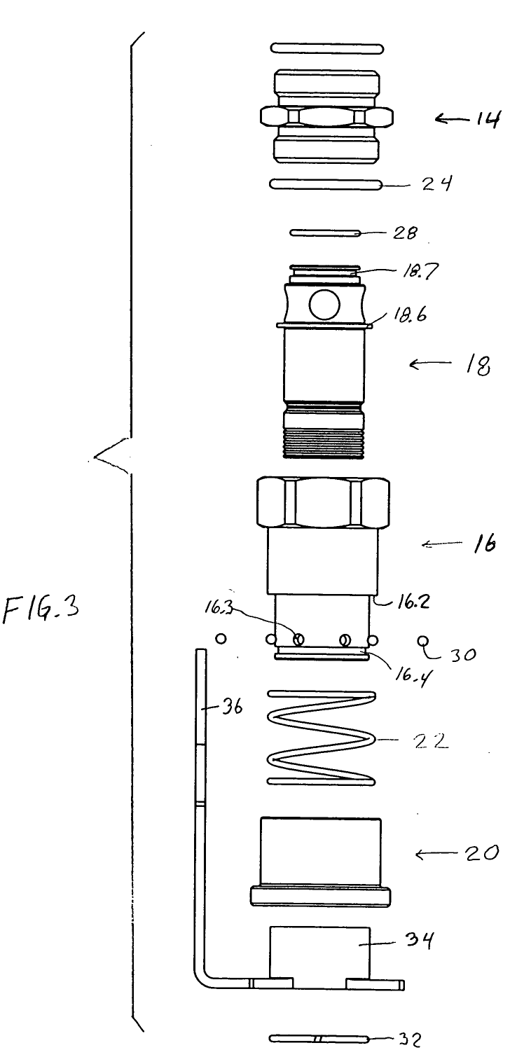

FIG. 4 is a perspective view similar to FIG. 3.

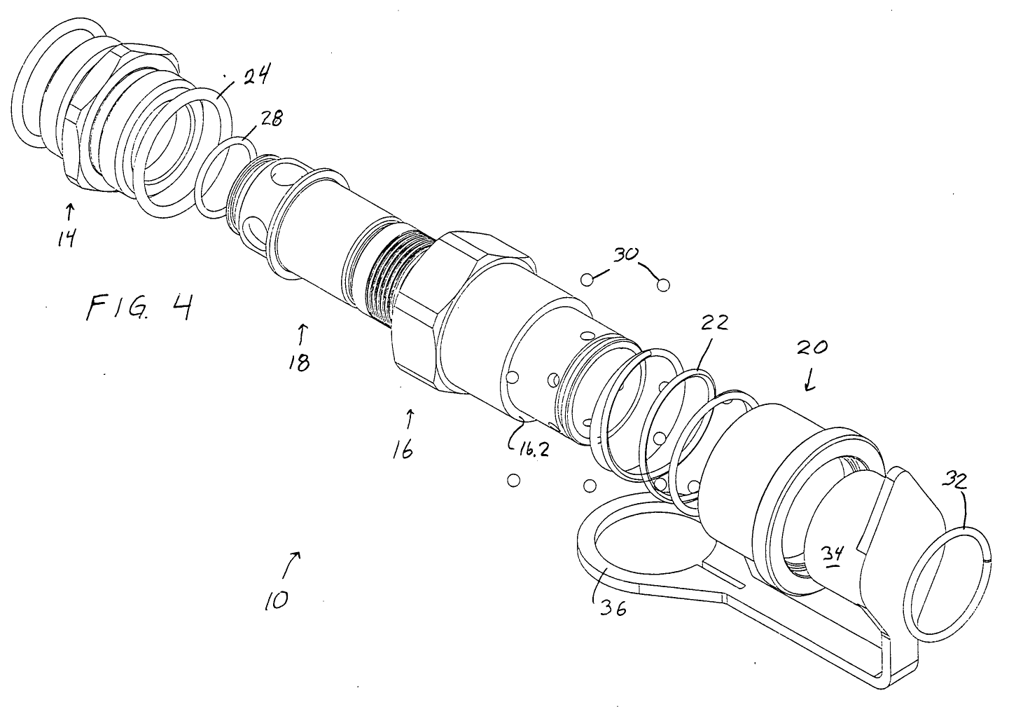

### DETAILED DESCRIPTION

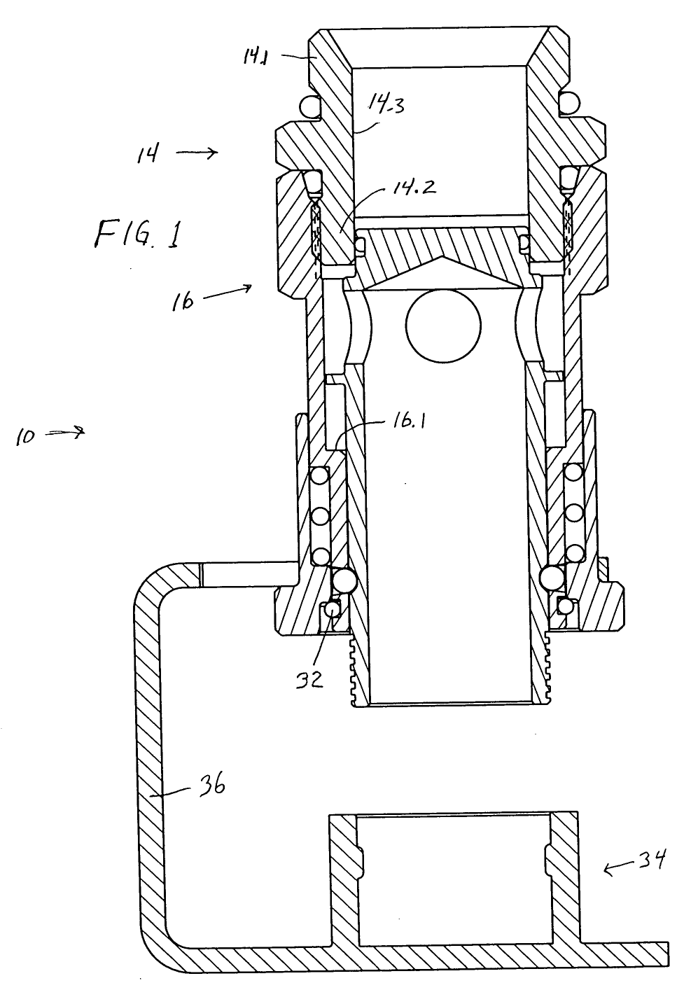

With reference to the various figures, the quick opening drain plug assembly of this invention is indicated generally at 10 which is adapted to be secured to a radiator header, a portion of which is shown at 12. Principal components of the plug assembly are a tubular fitting indicated generally at 14, a tubular socket body indicated generally at 16, a slidably mounted valve indicated generally at 18, a slidable collar 20, and a spring 22. The fitting 14 has first and second ends 14.1 and 14.2, respectively. The first end 14.1 is adapted to connect the drain plug assembly 10 to the radiator header 12. A passageway 14.3 extends from the first end 14.1 to the second end 14.2. As can be seen from FIG. 1, the first end 14.1 of the fitting 14 may be screwed into the radiator header 12. In addition, the tubular socket body 16 is screwed onto the fitting 14, and an O-ring 24 is provided to prevent leakage between the fitting 14 and the body 16.

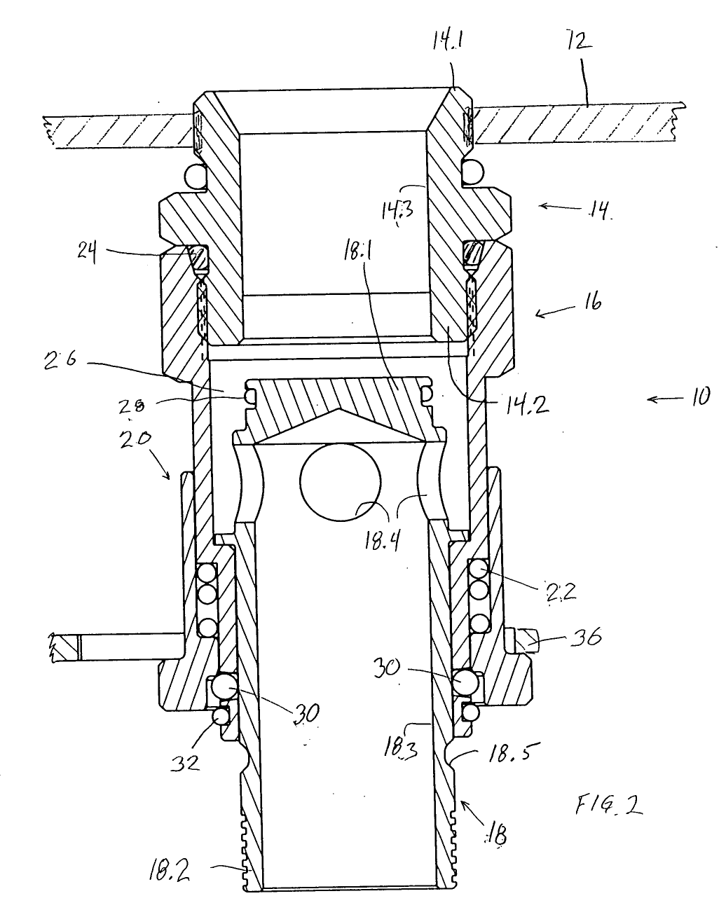

An abutment surface 16.1 is provided on the interior of the socket body 16. The slidably mounted valve 18 is located within the socket body 14. It has first and second ends 18.1 and 18.2, respectively. A cylindrical recess or passageway 18.3 extends from the second end 18.2 to the closed first end 18.1. A multiplicity of side ports 18.4, located away from the closed end 18.1, extend from the exterior of the valve 18 into the cylindrical recess 18.3. The valve 18 can slide back and forth between two positions, closed as shown in FIG. 1, and open as shown in FIG. 2. In the open position, the valve is somewhat extended from its closed position. The side ports 18.4 are of such a number and size that they permit the rapid draining of fluid from the header and the associated reservoir.

When the valve is in the open position, the flow of the fluid is through the tubular fitting 14, through a circumferential passageway 26 (FIG. 2) that runs past the closed end 18.1 of the valve and through the side ports 18.4 in the valve to the interior of the valve, and through the tubular passageway 18.3 on the interior of the valve that runs to the open end 18.4 of the valve. When the valve 18 is in the closed position, fluid flow from the reservoir is blocked. To this end, the valve has a circumferential groove, 18.5, toward the open end and an outwardly extending flange, 18.6, on the exterior of the valve, between the side ports and the groove 18.5. The flange limits the movement of the valve to an open position when it contacts the internal abutment 16.1 on the socket body 16. The nose portion 18.1 of the valve has a reduced diameter from the rest of the valve. The nose portion is provided with a groove 18.7 and an O-ring 28 is positioned in the groove to form a fluid-tight seal with the fitting 14 when the valve is in its closed position.

The movement of the valve is limited such that when open, the closed end will lie outside the fitting and interior to the tubular socket body. The circumferential space 26 is between the socket body and the valve for fluid flow when the valve is in the open position.

Means to limit the movement of the moveable valve to the open position include the valve flange 18.6 and socket body abutment 16.1. Means to hold the valve in either a closed or an open position include the collar 20, carried by the socket body, the compression spring 22, which extends between the external abutment 16.2 on the socket body 16, and an internal abutment 22.1 on the collar 22. The compression spring 22 normally biases the collar to the extended position, and a plurality of balls 30, are carried by a plurality of apertures 16.3 in the socket body. The collar is movable between extended and retracted positions to hold the valve in either a closed or an open position, respectively. A split ring 32 which is received in groove 16.4 limits movement of the collar in its extended position. When the collar is in the extended position, and a tight fluid-proof seal is formed between the fitting and the valve when the valve is in its closed position. When the collar is moved to compress the spring, the balls are released from the groove, and the pressure of the fluid within the radiator will force the valve 18 to its open position. To close the valve, it is only necessary to push the valve 18 towards the fitting 14, and when it approached the closed position, the spring will force the balls back into the groove to hold the parts together in the closed position.

A protective rubber cap 34 fits over the open end of the valve and is affixed to the valve assembly with an integral lanyard 36.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A quick opening drain plug assembly comprising:
a tubular fitting having first and second ends, the first end being adapted to be connected to a fluid reservoir, the fitting having a passageway extending from the first end to the second end;
a tubular socket body secured to the second end of the fitting;
a valve slidably mounted within the tubular socket body for sliding movement between open and closed positions, the valve having a tubular passageway which extends to an open end of the valve, the other end being closed, and side ports extending from an outer surface of the valve to the tubular passageway adjacent the closed end of the valve;
means to hold the valve in either a closed position or an open position; and
means to limit movement of the valve to the open position;
the valve when in the closed position blocking the flow of fluid from the reservoir through the fitting, but when in the open position permitting fluid to drain from the fluid reservoir.

2. The quick opening drain plug assembly as set forth in claim 1 wherein the valve is provided with a circumferential groove, and the means to hold the valve in the closed position includes a collar carried by the socket body and movable between extended and retracted positions to hold the valve in either a closed or an open position, respectively, a spring which normally biases the collar to the extended position, and balls carried by a plurality of apertures in the socket body, the balls being forced into the groove by the spring biased collar when it is in its extended position.

3. The quick opening drain plug assembly as set forth in claim 2 wherein the collar is provided with an internal flange.

4. The quick opening drain plug assembly as set forth in claim 2 in which the spring biased collar in the retracted position will release the balls from the groove, thus allowing the valve to move to an open position.

5. The quick opening drain plug assembly as set forth in claim 3 in which the internal flange of the collar is provided with a cam surface which rests on the balls when the valve is in the open position, thus keeping the collar in the retracted position.

6. The quick opening drain plug assembly as set forth in claim 1 in which the movement of the moveable valve is limited such that when the valve is in its open position, the closed end of the valve will lie outside the fitting and interior to the tubular socket body.

7. The quick opening drain plug assembly as set forth in claim 1 in which a tight fluid-proof seal is formed between the fitting and the moveable valve, when the valve is in its closed position.

8. The quick opening drain plug assembly as set forth in claim 1 in which the means to limit movement of the valve to the open position includes an abutment surface on the interior of the socket body and an outwardly extending flange on the valve to form a tight, fluid-proof seal on the exterior of the valve.

9. The quick opening drain plug assembly as set forth in claim 8 in which, when the moveable valve is in its open position, the fluid flow path is from the reservoir, through the fitting, through a circumferential space between the socket body and the valve, through the side ports in the valve, and out through the open end of the valve.

10. The quick opening drain plug assembly as set forth in claim 1 in which the side ports in the moveable valve are of such a number and size that they permit the rapid draining of fluid from the reservoir through them.

11. The quick opening drain plug assembly as set forth in claim 1 wherein, when the moveable valve is in an open position, pushing the valve towards its closed position will cause the cam surface to force the balls into the groove when the groove is below the balls, which will then permit the spring to force the collar into its extended position, locking the valve in its closed position.

12. The quick opening drain plug assembly as set forth in claim 1 in which a protective rubber cap which fits over the open end of the valve is affixed to the valve assembly with an integral lanyard.

13. The quick opening drain plug assembly as set forth in claim 1 wherein the closed end of the valve is provided with a reduced diameter nose portion which is received within the passageway of the fitting.

14. The quick opening drain plug assembly as set forth in claim 13 wherein the nose position of the valve is provided with a groove, and wherein an O-ring is received in the groove to form the fluid tight seal with the fitting when the valve is in its closed position.
